(19) United States
(12) Patent Application Publication
(10) Pub. No.: US 2002/0034666 A1
(43) Pub. Date: Mar. 21, 2002

(54) Magnetic recording medium utilizing patterned nanoparticle arrays

(76) Inventor: James Dillon Kiely, Sewickley, PA (US)

Correspondence Address: Alan G. Towner, Pietragallo, Bosick & Gordon, One Oxford Centre, 38th Floor, 301 Grant Street, Pittsburgh, PA, 15219, US

(21) Appl. No.: 09/949,092

(22) Filed: Sep. 7, 2001

Related U.S. Application Data
(60) Provisional application No. 60/230,877, filed on Sep. 7, 2000.

(51) Int. Cl. G11B 5/66

(52) U.S. Cl. 428/694 TS

(57) ABSTRACT

A method of patterning a layer of ferromagnetic metallic nanoparticles for use as a portion of a magnetic recording medium is provided. The method involves providing a substrate and coating the substrate with an unmodified affinity layer. Portions of the unmodified affinity layer are exposed to a reactive material that chemically modifies the affinity layer. The modified portions are chemically attractive to the nanoparticles. The nanoparticles are then deposited on the chemically modified portions of the affinity layer. A recording medium comprising a substrate, a modified affinity layer and a ferromagnetic nanoparticle metallic layer is also disclosed.

### CROSS-REFERENCE TO RELATED APPLICATION

This application claims the benefit of U.S. Provisional Application Serial No. 60/230,877 filed Sep. 7, 2000, which is incorporated herein by reference.

### FIELD OF THE INVENTION

The present invention relates to magnetic recording media, and more specifically to patterning a ferromagnetic metallic layer on a substrate.

### BACKGROUND INFORMATION

In magnetic recording, patterning a substrate with a magnetic material is an important process in the manufacturing of both servo sectors and magnetic recording media. Traditionally, such patterning was achieved by sputtering onto a topographically patterned substrate. Substrate topographical patterns are established by etching or imprinting the substrate on which the media is deposited. However, this approach results in grain sizes on the order of 10's of nanometers (nm), which imposes a limitation on the ability to scale the design to smaller sizes. One of the major goals in patterning is to increase the density (i.e., the number of grains per square nm) of the magnetic material as deposited, while minimizing the individual particle size of the magnetic material.

In perpendicular magnetic recording, the read/write head reads and writes through a hard magnetic recording layer and a soft magnetic underlayer is used to direct magnetic flux back to the head. In order to maximize the efficiency of the read/write head, it is desirable to manufacture the hard magnetic recording layer as thin as possible. To that end, it is advantageous to minimize the size of the individual particles of the magnetic material. As the particle size decreases, the magnetic layer may be made thinner.

In longitudinal magnetic recording, the read/write head reads and writes data on the magnetic layer. When data is written, the individual particles are aligned to form packets of data. When the individual particle sizes of the magnetic layer are large, the packets of data may have irregularly shaped edges, leading to unacceptably low signal-to-noise ratios. It has been recognized that in order to increase the signal-to-noise ratio, the data packets should be densified. Also, the individual particle size should be decreased to allow for a more uniformly-shaped edge.

To achieve smaller individual particle sizes, the manufacture of monodisperse nanoparticles (particles having diameters of less than 50 nm) by the reduction of platinum acetylacetonate and decomposition of iron pentacarbonyl in the presence of oleic acid and oleyl amine stabilizers has been disclosed, and their use in magnetic storage media has been proposed. It is desirable to increase the densification of such nanoparticles in order to maximize the signal-to-noise ratio in magnetic recording media.

Furthermore, one of the goals in using nanoparticles in magnetic recording is to increase the recording density. The recording density is controlled by the magnetic layer grain size and the grain density (i.e. number of grains per square nm). Nanoparticles provide the potential to have individual grains represent a bit of information, thereby maximizing the recording density.

Patterned nanoparticles may by used for several different purposes. The first purpose is that of servo sectors. These are approximately 100-200 μm wide wedges with checkerboard-like patterns that are scattered around a disc. The servo sectors are used to tell the head where it is on the disc. The second purpose is bit patterned media, where the pattern is used to write the data in the form of 1's and 0's. Nanoparticles are advantageously used for both applications because the small grain size allows one to shrink the size of both the servo sectors and the data bits. However, in order to shrink the size of the servo sectors and the data bits, the patterned nanoparticles must be densified. Thus, a need exists for a method of increasing the density of the patterned nanoparticles.

### SUMMARY OF THE INVENTION

The present invention provides a method of patterning a nanoparticle array of a magnetic recording medium. The method includes providing a substrate having an affinity layer disposed thereon, modifying the affinity layer such that the modified affinity layer has a higher chemical affinity for the nanoparticles than the unmodified affinity layer, and coating the affinity layer with nanoparticles of a magnetic material to form a nanoparticle array.

The present invention also provides a magnetic recording medium comprising a substrate; an affinity layer comprising organic molecules having at least one functional endgroup disposed on the substrate; and a ferromagnetic metallic layer disposed on the affinity layer. The ferromagnetic metallic layer comprises nanoparticles of a metallic material and organic stabilizers. The organic stabilizers also have at least one functional endgroup. The functional endgroup of the organic molecules is chemically bonded to the functional endgroup of the organic stabilizers.

### BRIEF DESCRIPTION OF THE DRAWINGS

FIG. 1 is a schematic view of nanoparticles and stabilizing organic molecules used in accordance with the present invention.

FIG. 2 is a schematic view of a recording medium manufactured in accordance with the present invention.

FIG. 3a is a schematic view of a substrate with an unmodified affinity layer disposed thereon.

FIG. 3b is a schematic view of a substrate with a modified affinity layer disposed thereon.

FIG. 3c is a schematic view of a substrate with a modified affinity layer disposed thereon and a ferromagnetic metallic layer disposed on the modified affinity layer.

FIG. 4 is a schematic view of a recording medium manufactured suitable for longitudinal magnetic recording in accordance with an alternate embodiment of the present invention.

FIG. 5 is a schematic view of a recording medium manufactured suitable for perpendicular magnetic recording in accordance with an alternate embodiment of the present invention.

FIG. 6 is a schematic view of a patterned recording medium manufactured in accordance with the present invention.

### DETAILED DESCRIPTION OF THE INVENTION

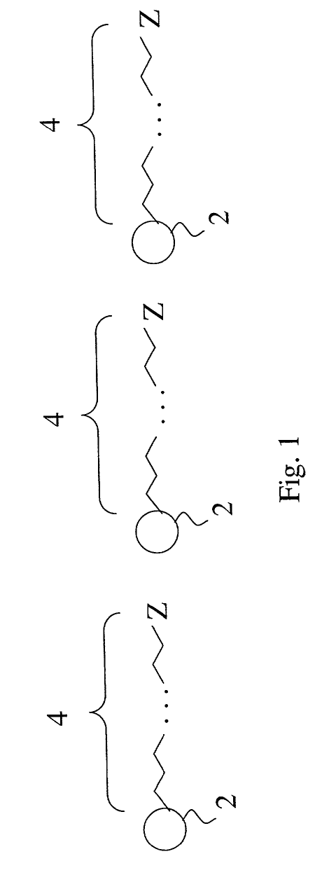

FIG. 1 shows individual nanoparticles 2 stabilized by organic molecules 4. The organic molecules typically consist of long chain organic compounds of the form R-Z, wherein R is a straight or branched carbon chain comprising six (6) to twenty-eight (28) carbon atoms or a straight or branched fluorocarbon chain comprising six (6) to twenty-eight (28) carbon atoms. R may also comprise amide or diacetylene moieties. Z may include, but is not limited to, acid chlorides, sulfonic acids, sulfinic acids, phosphinic acids, phosphonic acids, carboxylic acids, thiols, trismethoxysilane, trisethoxysilane, and trichlorosilane and combinations thereof. The length of the carbon chains may be chosen in order to optimize the spacing between the nanoparticles 2. Typically, the spacing between the nanoparticles is approximately one (1) to five (5) nm.

In choosing the organic molecules 4 to be used as stabilizers, it is advantageous to select Z such that the organic molecules 4 are chemically attractive to the modified affinity layer. However, if the organic molecules are chemically attractive to one another, unwanted agglomeration of the nanoparticles 2 will occur.

The nanoparticles 2 comprise ferromagnetic particles with a diameter of from one (1) to ten (10) nm, and comprising a material such as elements Co, Fe, Ni, Mn, Sm, Nd, Pr, Pt, Gd, C, B, Zr, an intermetallic compound of the aforesaid elements, a binary alloy of said elements, a ternary alloy of said elements, an oxide of Fe further comprising at least one of said elements other than Fe, barium ferrite and strontium ferrite. The nanoparticles 2 and organic molecules 4 can be produced by any suitable methods known in the art.

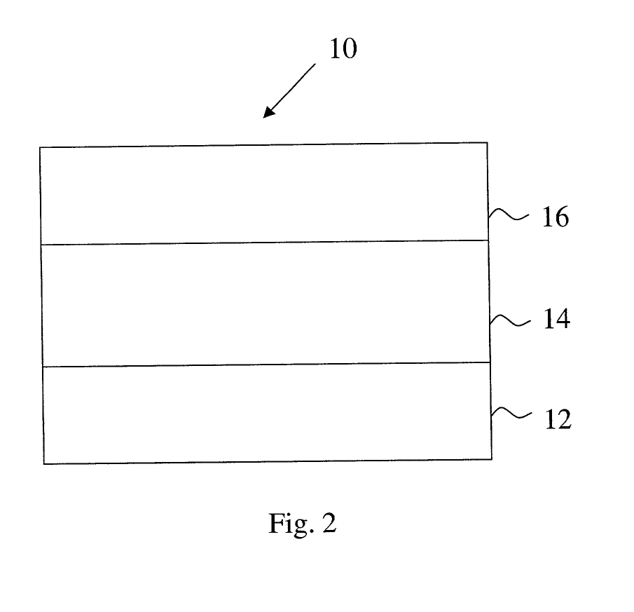

FIG. 2 illustrates a magnetic recording medium 10 manufactured in accordance with the present invention. The magnetic recording medium 10 comprises a substrate 12, a modified affinity layer 14 and a ferromagnetic metallic layer 16, the ferromagnetic metallic layer 16 comprising nanoparticles 2 and organic molecules 4. A suitable thickness for the ferromagnetic metallic layer 16 is from approximately one (1) to thirty (30) nm, for example, approximately four (4) to ten (10) nm.

As used herein, “modified affinity layer” means an affinity layer that has been chemically modified to have a higher chemical affinity for the ferromagnetic metallic layer 16 than an unmodified affinity layer 13 that was deposited on the substrate 12.

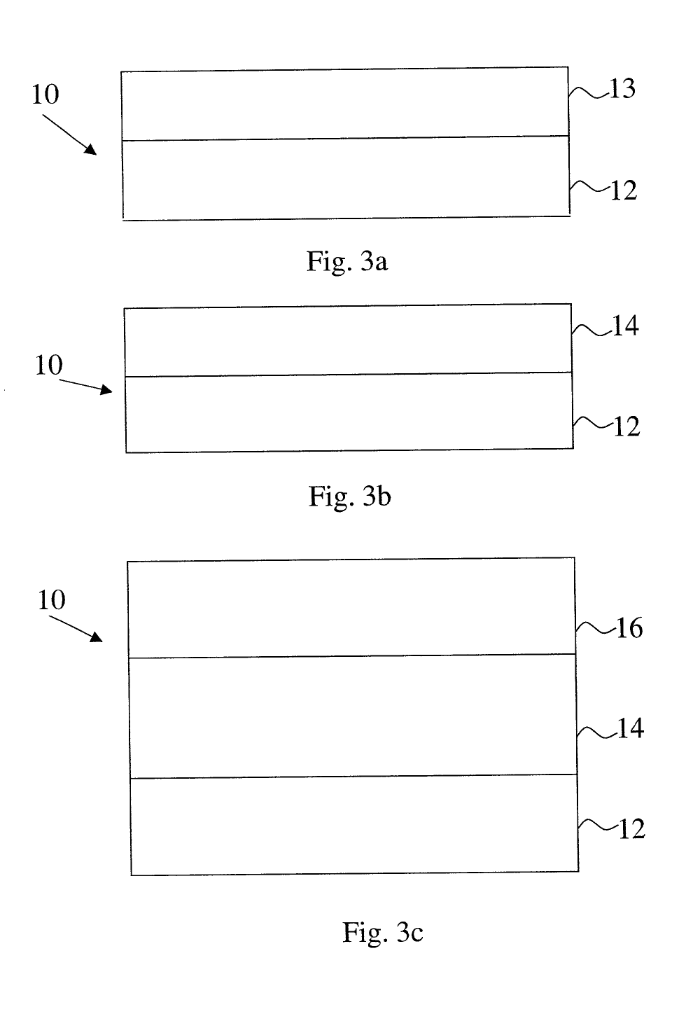

FIG. 3a shows the substrate 12 with an unmodified affinity layer 13 disposed thereon. The unmodified affinity layer 13 is subsequently chemically modified to become the modified affinity layer 14 shown in FIG. 3b.

The substrate 12 comprises any suitable material known in the art that can be used as a recording medium substrate. It is advantageous if the substrate 12 is chosen so as to be particularly receptive to the unmodified affinity layer 13. Typically the substrate 12 comprises Si, glass or aluminum, but the substrate 12 may also comprise a magnetic soft underlayer film in the case of perpendicular recording, an adhesion layer such as Au, Ag, or other metal film to which the affinity layer may be attached, and a passivation layer to passivate underlying magnetic layers from corrosion if the medium is going to be used for perpendicular recording.

The unmodified affinity layer 13 is formed on the substrate 12 by any suitable means, for example, by microcontact printing, dip coating, stamping, and scanning probe-based lithography. In accordance with an embodiment of the present invention, unmodified affinity layer 13 comprises organic molecules or materials having two functional endgroups X and Y′. The first endgroup, X, is selected such that it is chemically attractive to the substrate 12. Thus, as the unmodified affinity layer 13 is formed on the substrate 12, the endgroup X will form a bond with the substrate 12. The second endgroup, Y′, is modified subsequent to the formation of the unmodified affinity layer 13 to become endgroup Y. As such, the endgroup Y′ will be selected based upon the desired endgroup Y. The endgroup Y has a higher chemical affinity for the endgroup Z of the organic molecules 4 than the endgroup Y′.

The unmodified affinity layer 13 comprises bi-functional molecules of the form X-R-Y′, wherein R may include hydrocarbon and fluorocarbon chains of between three (3) and twenty-two (22) carbon atoms. R may also include amide or diacetylene moieties. X is selected from acid chlorides, sulfonic acids, sulfinic acids, phosphinic acids, phosphonic acids, carboxylic acids, thiols, trismethoxysilane, trisethoxysilane, and trichlorosilane, and combinations thereof, and Y′ is selected from thiols, methyl, trifluromethyl, hydroxyls, esters, vinyls, bromides, carboxylic acids, amines, acid chlorides, sulfonic acids, sulfinic acids, phosphinic acids and phosphonic acids.

As will be discussed in further detail below, the endgroup Y′ is chemically modified to become the endgroup Y. As a result, the unmodified affinity layer 13 shown in FIG. 3a becomes the modified affinity layer 14 shown in FIG. 3b. The modified affinity layer 14 comprises organic molecules or materials with two functional endgroups X and Y. The endgroup X forms a bond with the substrate 12 as described above. One purpose of the modified affinity layer 14 is to effectively adhere the ferromagnetic metallic layer 16 to the substrate 12 as shown in FIG. 3c. This may be accomplished by bonding the functional endgroup X of the organic molecules 4 to endgroup Y of the modified affinity layer 14. As such, endgroup Y is selected so as to have a high chemical attraction to endgroup X of the organic molecules 4.

The modified affinity layer 14 comprises bi-functional organic molecules of the form X-R-Y, wherein R is selected from hydrocarbon and fluorocarbon chains of between three (3) and twenty-two (22) carbon atoms. R may include amide or diacetylene moieties. X is selected from the groups consisting of acid chlorides, sulfonic acids, sulfinic acids, phosphinic acids, phosphonic acids, carboxylic acids, thiols, trismethoxysilane, trisethoxysilane, and trichlorosilane and combinations thereof and Y is selected from sulfonic acids, thiols, carboxylic acids, amides, hydroxyl groups, pyridines, methyl ether, and acetates.

As can be appreciated, the endgroup Y of the modified affinity layer 14 will have a higher chemical affinity for endgroup Z of the organic molecules 4 than the endgroup Y′. Typically, the endgroup Y′ will be reacted with a reactive material or specific types of light to yield the endgroup Y. The reactive species will be selected based upon the endgroup Y′ that is used and the desired endgroup Y. Suitable types of light includes ultraviolet (UV), deep ultraviolet (DUV), and extreme ultraviolet (EUV). Suitable reactive materials include, for example, SOCl₂, methoxycarbonyls, N-hydroxysuccinimide esters, alkanoic acids, and acid chlorides.

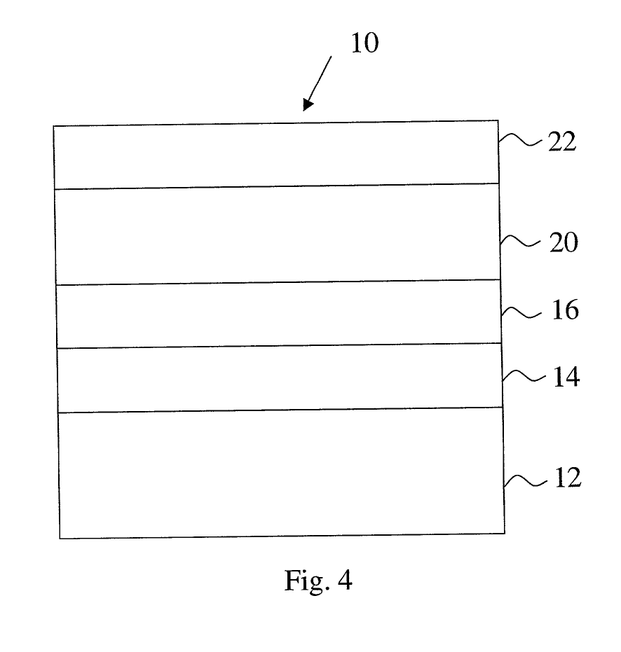

In an embodiment illustrated in FIG. 4, the recording medium 10 is particularly suitable for longitudinal magnetic recording, and may further comprise a hard protective layer 20 and/or a lubricating layer 22 disposed on the ferromagnetic metallic layer 16. Suitable materials for the hard protective layer 20 include a-C:H, a-C:N, a-C:HN, SiC, Zr₂O₃, Zr₂O₃/Al₂O₃, B₄C, and a-BCN. Suitable materials for lubricating layer 22 include solid lubricant layers such as a-C:F,H and liquid lubricant layers, such as perfluropolyethers and other lubricants known to those in the art.

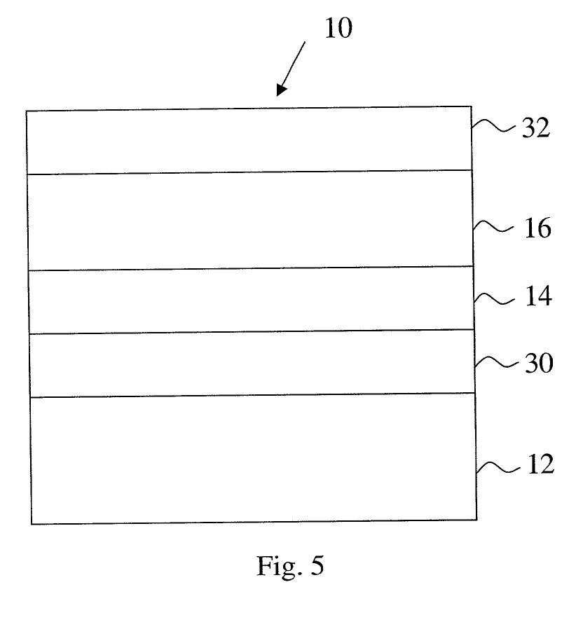

FIG. 5 illustrates another embodiment wherein the recording medium 10 is particularly suitable for perpendicular magnetic recording. Recording medium 10 further comprises a soft magnetic underlayer 30 disposed between the substrate 12 and the modified affinity layer 14 and a hard protective layer 32 disposed on the ferromagnetic metallic layer 16. Suitable materials for soft magnetic underlayer 30 include, for example, FeCoB, FeCoZr and NiFe and the like. Suitable materials for the hard protective layer 32 include, for example, diamond like carbon, amorphous C or Si, oxides such as aluminum oxide or Si oxide, SiC, Zr₂O₃, Zr₂O₃/Al₂O₃, and B₄C. A lubricating layer (not shown) may optionally be deposited on the protective layer 32. Suitable materials for the lubricating layer include solid lubricant layers such as a-C:F,H, as well as other materials known to those in the art, and liquid lubricant layers, such as perfluropolyethers.

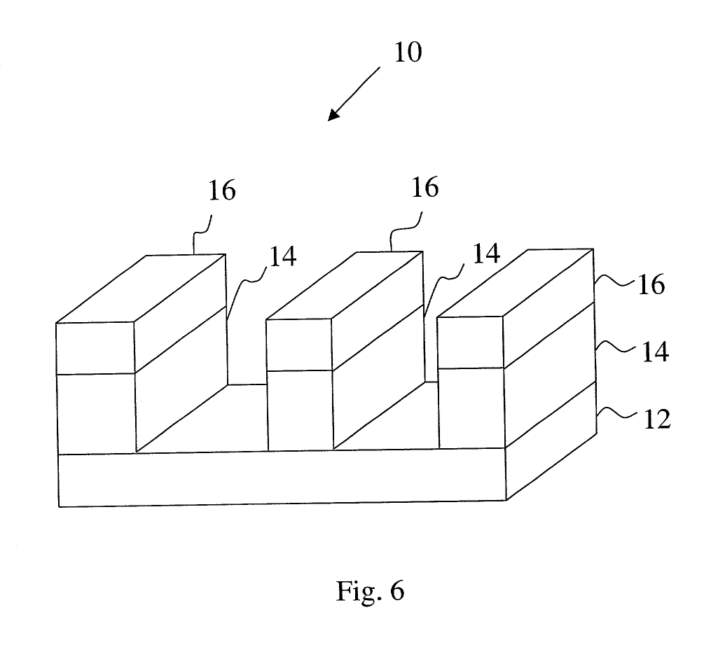

An additional feature in accordance with an embodiment of the present invention involves the ability to pattern the affinity layer and/or the ferromagnetic metallic layer 16 in order to produce patterned nanoparticle arrays as illustrated in FIG. 6. Some types of patterns for use in recording media include patterned servo sectors, circumferential grooves, and patterned data regions. It will be appreciated by those skilled in the art that a desired pattern of the ferromagnetic metallic layer 16 may be formed by forming the same desired pattern in either the unmodified affinity layer 13 or the modified affinity layer 14. The unmodified affinity layer 13 may be coated onto the substrate 12 as a solid layer as described above, or as a patterned layer. It is coated as a patterned layer by methods such as microcontact printing, stamping, masking, and replica molding. The patterned, unmodified affinity layer 13 is then reacted with the reactive material to produce a patterned, modified layer 14. In this embodiment, the reactive material must be chosen so as not to be reactive or corrosive to the substrate 12, as the uncoated portions of the substrate 12 may contact the reactive material.

The unmodified affinity layer 13 may also be coated onto the substrate 12 as a solid layer and patterned after it is coated onto the substrate 12. The unmodified affinity layer 13 is patterned by conventional methods, for example, photo-lithography, focused ion-beam etching, electron beam writing, and scanning probe microscopy writing.

After the ferromagnetic metallic layer 16 is coated on the modified affinity layer 14, the ferromagnetic metallic layer 16 may need to be heat treated. For example, in the case of ferrite nanoparticles, no heat treatment is necessary. However, in the case of FePt nanoparticles, heat treating at a temperature above 550° C., for example, from 550 to 600° C., is necessary to convert them from non-magnetic face-centered cubic to magnetic face-centered tetragonal. A suitable heat treatment for the ferromagnetic metallic layer 16 if it is comprised of FePt nanoparticles is to heat it to 560° C. for 30 minutes.

As an example of the above-described process, a substrate comprising Si is coated with a carboxylic acid-terminated alkyltrichlorosilane monolayer, namely carboxylic acid terminated actadecyltrichlorosilane, COOH(CH₂)₁₇SiCl₃. In this example, the carboxylic acid functional group, COOH, serves as the endgroup Y′. FePt nanoparticles are synthesized using hexanoic acid and hexylamine as organic molecule stabilizers. This produces inter-particle spacing of approximately 1 nm. As the organic molecules have thiol endgroups, it is desired for the affinity layer endgroup Y to have an acid chloride moiety, as this is chemically attractive to the thiol-terminated nanoparticle stabilizers. The unmodified affinity layer is masked in selected areas to form a desired pattern. The un-masked portions are then exposed to UV light. The UV light chemically lowers the binding energy between the affinity layer and the substrate. The un-masked portions are then rinsed off of the substrate using ethyl alcohol.

The functionalization of the remaining portion of the affinity layer is changed to that of an acid chloride moiety by exposing the carboxylic acid-terminated monolayer to SOCl₂ vapor. The modified affinity layer now has functional groups Y (acid chlorides) that are attractive to the functional groups of the organic molecules Z (thiols). The metallic nanoparticles and organic molecule stabilizers are deposited onto the remaining sections of the affinity layer. Because of the chemical attraction between the acid chlorides and the thiols, the resulting ferromagnetic metallic layer is a well-ordered, dense assembly of nanoparticles. Thus, the patterned nanoparticles have an increased density, which allows the recording density to be maximized.

Whereas particular embodiments of this invention have been described above for purposes of illustration, it will be evident to those skilled in the art that numerous variations of the details of the present invention may be made without departing from the invention as defined in the appended claims.

What is claimed is:

1. A method of making a magnetic recording medium comprising:
providing a substrate having an affinity layer disposed thereon;
modifying the affinity layer; and
coating the modified affinity layer with a ferromagnetic metallic layer, wherein the modified affinity layer has a higher chemical affinity for the ferromagnetic metallic layer than the unmodified affinity layer.

2. The method of claim 1, wherein the ferromagnetic metallic layer comprises nanoparticles and organic stabilizers.

3. The method of claim 1, wherein the affinity layer is modified by exposing the affinity layer to a reactive material.

4. The method of claim 1, wherein the affinity layer is modified by exposing the affinity layer to light.

5. The method of claim 2, wherein the nanoparticles comprise elements Co, Fe, Ni, Mn, Sm, Nd, Pr, Pt, Gd, C, B, Zr, an intermetallic compound of the elements, a binary alloy of the elements, a ternary alloy of the elements, an oxide of Fe further comprising at least one of the elements other than Fe, barium ferrite and strontium ferrite.

6. The method of claim 2, wherein the organic stabilizers comprise organic compounds of the form R-Z, wherein R is a straight or branched carbon chain comprising 3 to 28 carbon atoms or a straight or branched fluorocarbon chain comprising 3 to 28 carbon atoms and wherein Z includes acid chlorides, sulfonic acids, sulfinic acids, phosphinic acids, phosphonic acids, carboxylic acids, thiols, trismethoxysilane, trisethoxysilane, trichlorosilane or a combination thereof.

7. The method of claim 6, wherein R further comprises amide and/or diacetylene.

8. The method of claim 1, wherein the wherein the unmodified affinity layer comprises bi-functional molecules of the form X-R-Y′, wherein R is selected from hydrocarbon and fluorocarbon chains of between 3 and 28 carbon atoms, X is selected from acid chlorides, sulfonic acids, sulfinic acids, phosphinic acids, phosphonic acids, carboxylic acids, thiols, trismethoxysilane, trisethoxysilane, and trichlorosilane, and Y′ is selected from thiols, methyls, tri-fluromethyls, hydroxyls, esters, vinyls, bromides, carboxylic acids, amines, acid chlorides, sulfonic acids, sulfinic acids, phosphinic acids and phosphonic acids.

9. The method of claim 8, wherein R further comprises amide and/or diacetylene moieties.

10. The method of claim 3, wherein the reactive material comprises SOCl₂, methoxycarbonyls, N-hydroxysuccinimide esters, alkanoic acids, acid chlorides or a combination thereof.

11. The method of claim 4, wherein the light is selected from ultraviolet light, deep ultraviolet light and extreme ultraviolet light.

12. The method of claim 1, wherein the modified affinity layer comprises bi-functional molecules of the form X-R-Y, wherein R is selected from hydrocarbon and fluorocarbon chains of between 3 and 22 carbon atoms, X is selected from acid chlorides, sulfonic acids, sulfinic acids, phosphinic acids, phosphonic acids, carboxylic acids, thiols, trismethoxysilane, trisethoxysilane and trichlorosilane, and Y is selected from acid chlorides, sulfonic acids, thiols, carboxylic acids, amides, hydroxyl groups, pyridines, methyl ether and acetates.

13. The method of claim 12, wherein R further comprises amide and/or diacetylene moieties.

14. The method of claim 1, wherein the ferromagnetic metallic layer is patterned.

15. The method of claim 14, further comprising:
masking selected areas of the affinity layer;
exposing the affinity layer to UV light sufficient to lower the binding energy between the substrate and the affinity layer; and
removing the un-masked portion of the affinity layer from the substrate.

16 The method of claim 15, wherein the masking, exposing and removing are performed prior to modifying the affinity layer.

17. The method of claim 15, wherein the masking, exposing and removing are performed subsequent to modifying the affinity layer.

18. The method of claim 15, wherein the unmasked portion of the affinity layer is removed from the substrate prior to coating the affinity layer with the ferromagnetic metallic layer.

19. The method of claim 15 further comprising heat treating the ferromagnetic metallic layer.

20. The method of claim 19, wherein the heat treating is performed at a temperature of from 550 to 600° C.

21. A magnetic recording medium comprising:
a substrate;
a modified affinity layer comprising organic molecules disposed on the substrate; and
a ferromagnetic metallic layer disposed on the modified affinity layer.

22. The recording medium of claim 21, wherein the ferromagnetic metallic layer comprises nanoparticles and organic stabilizers.

23. The recording medium of claim 21, wherein the organic molecules are of the form X-R-Y, wherein R is selected from hydrocarbon and fluorocarbon chains of between 3 and 22 carbon atoms, X is selected from acid chlorides, sulfonic acids, sulfinic acids, phosphinic acids, phosphonic acids, carboxylic acids, thiols, trismethoxysilane, trisethoxysilane and trichlorosilane, and Y is selected from acid chlorides, sulfonic acids, thiols, carboxylic acids, amides, hydroxyl groups, pyridines, methyl ether and acetates.

24. The recording medium of claim 23, wherein R further comprises amide and/or diacetylene moieties.

25. The recording medium of claim 23, wherein Y comprises sulfonic acids, thiols, carboxylic acids, amides, hydroxyl groups, pyridines, methyl ether, acetates or a combination thereof.

26. The recording medium of claim 23, wherein Y is selected from the group consisting of carboxylic acids and hydroxyl groups.

27. The recording medium of claim 22, wherein the organic stabilizers comprise organic compounds of the form R-Z, wherein R is a straight or branched carbon chain comprising 3 to 22 carbon atoms or a straight or branched fluorocarbon chain comprising 3 to 22 carbon atoms, and wherein Z includes acid chlorides, sulfonic acids, sulfinic acids, phosphinic acids, phosphonic acids, carboxylic acids, thiols, trismethoxysilane, trisethoxysilane, trichlorosilane or a combination thereof.

28. The recording medium of claim 27, wherein R further comprises amide and/or diacetylene moieties.

29. The recording medium of claim 21, wherein the nanoparticles comprise elements Co, Fe, Ni, Mn, Sm, Nd, Pr, Pt, Gd, C, B, Zr, an intermetallic compound of the elements, a binary alloy of the elements, a ternary alloy of the elements, an oxide of Fe further comprising at least one of the elements other than Fe, barium ferrite and strontium ferrite.

30. The recording medium of claim 21, wherein the substrate comprises a material selected from Si, glass and aluminum.

31. The recording medium of claim 21, wherein the ferromagnetic metallic layer is disposed on the affinity layer in a preselected pattern.

32. The recording medium of claim 21, further comprising a hard protective layer disposed on the ferromagnetic layer and a lubricating layer disposed on the hard protective layer.

33. The recording medium of claim 32, wherein the hard protective layer comprises a material selected from a-C:H, a-C:N, a-C:H, N, SiC, Zr₂O₃, Zr₂O₃/Al₂O₃, B₄C and a-BCN.

34. The recording medium of claim 32, wherein the lubricating layer comprises a perfluropolyether.

35. The recording medium of claim 21, further comprising a soft magnetic underlayer disposed between the substrate and the modified affinity layer.

36. The recording medium of claim 35, wherein the soft magnetic underlayer comprises a material selected from FeCoB, FeCoZr and NiFe.
